(19) United States
(12) Patent Application Publication
(10) Pub. No.: US 2026/0130385 A1
(43) Pub. Date: May 14, 2026

(54) TREATMENT OF REFRIGERATED PRE-COOKED EGG FOOD PRODUCTS

(71) Applicant: Cargill, Incorporated, Wayzata, MN (US)

(72) Inventors: Samuel Edward Kessler, Hopkins, MN (US); Subash Shrestha, Wichita, KS (US)

(73) Assignee: Cargill, Incorporation, Wayzata, MN (US)

(21) Appl. No.: 18/706,069

(22) PCT Filed: Nov. 2, 2022
(86) PCT No.: PCT/US2022/079120

§ 371 Date: Apr. 30, 2024

Related U.S. Application Data
(60) Provisional application No. 63/274,631, filed on Nov. 2, 2021.

(51) Int. Cl. A23B 5/14; A23B 5/04; A23L 15/00

(52) U.S. Cl. CPC A23B 5/14; A23B 5/04; A23L 15/30

(57) ABSTRACT

A method for preparing a refrigerated, pre-cooked egg based product is disclosed. The method includes combining a liquid egg material with an antibacterial composition comprising nisin, citric acid, and an secondary organic acid having a pKa of from about 3.5 to about 8 to form a liquid egg formulation with surprisingly good control of Listeria growth.

### CROSS-REFERENCE TO RELATED APPLICATIONS

This application claims the benefit of U.S. Provisional Patent Application No. 63/274,631, filed 2 Nov. 2021, which is hereby incorporated by reference in its entirety.

### FIELD

The present invention relates to egg products. More specifically, the present application relates to refrigerated, pre-cooked egg food products.

### BACKGROUND

Methods and compositions for inhibiting Listeria growth in pre-cooked egg products during refrigeration are described in US Patent Application Publication No. 2010/0129501, wherein a liquid egg material is combined with an antibacterial composition including nisin and one or more organic acids or salts thereof prior to cooking.

US Patent Application Publication No. US 2008/0095885 discloses a method of controlling the development of resident spoilage and pathogenic bacteria in food products by introducing, into the food products, known bacteria that produce novel bacteriocins or metabolites which inhibit or kill the spoilage and pathogenic bacteria. Also disclosed in the use of modified-atmosphere packaging (“MAP”) in packaging pre-cooked egg material in low oxygen modified atmosphere in paragraph [0042].

### SUMMARY

Ready-to-eat breakfast products such as scrambled eggs, breakfast sandwiches, breakfast burritos and the like typically include a pre-cooked egg material such as a pre-cooked egg filling, patty or loaf. As used herein, “pre-cooked” refers to an egg material that is cooked and then stored for extended periods under conditions (e.g., packaging conditions, temperature conditions, etc.) suitable for commercial distribution and sale prior to consumption. These pre-cooked egg materials are typically formed from a mixture of liquid whole egg or egg whites and optional edible non-egg materials such as meats, cheeses, or vegetables and/or other optional ingredients. The liquid egg material is then cooked, for example, by conventional scrambling techniques or by depositing the liquid egg material in an egg pan and cooking in an oven to form a patty or other insert. The resulting pre-cooked egg material is optionally combined with other food materials (e.g., bagels, croissants, tortillas, sausage patties, etc.) and packaged for distribution and sale. Such pre-cooked products generally remain frozen up until the time of consumption to reduce the chance of spoilage, decomposition or food safety risks caused by, for example, bacterial growth.

Although it would be beneficial in many cases to provide refrigerated pre-cooked products that do not need to be frozen up until the time of consumption, concerns relating to bacterial growth and food safety have posed a barrier to such a refrigerated product. One such bacteria that occurs in egg products is Listeria monocytogenes (“Listeria”). The U.S. Department of Agriculture (USDA) encourages refrigerated food products to have no more than 2 log average Listeria growth over the shelf life of the refrigerated product. Without treatment, however, pre-cooked egg products may exceed 2 log Listeria growth in less time than desirable to provide a suitable refrigerated shelf life.

Nisin is an inhibitory polycyclic peptide with 34 amino acid residues. It contains the amino acids lanthionine, methyllanthionine, dehydroalanine and dehydro-amino-butyric acid. Nisin is produced by fermentation using the bacterium Lactococcus lactis. Due to its highly selective spectrum of activity, nisin is employed as a selective agent in microbiological media for the isolation of gram-negative bacteria, yeast and molds.

While nisin is recognized for its antimicrobial properties, there is a desire to use this material in low quantities. For, example, the USDA in general requires that nisin should be present in compositions at a concentration range of 6.25 ppm or less, and occasionally grants exceptions to use higher quantities in certain products. The present methods permit preparation of refrigerated pre-cooked egg food products that exhibit surprisingly good control of Listeria growth that can even exceed the degree of control recommended by the USDA without adverse effects on organoleptic properties, with very low amounts of nisin being present in the final food product.

It has been found that a refrigerated, pre-cooked egg based product may be prepared by combining a liquid egg material with an antibacterial composition comprising nisin, citric acid, and a secondary organic acid or salt to form a liquid egg formulation comprising nisin in an amount of about 6.25 ppm or less, citric acid, and a secondary organic acid or a salt thereof that is suitable for use in food, the secondary organic acid having a pKa of from about 3.5 to about 8. In an aspect, the secondary organic acid has a pKa of from about 4 to about 6. In an aspect, the secondary organic acid has a pKa of from about 4 to about 5. While not being bound by theory, it is believed that the nisin present in the composition acts to adversely affect the viability of the cells of the bacteria and additionally to adversely affect germination of spores associated with the bacteria, while the secondary organic acid or salt thereof likewise adversely affects the viability of the cells of the bacteria either alone or in concert with nisin. By providing the secondary organic acid in a product pH environment of from about 5.5 to about 6.25, it is believed that the acid form of the secondary organic acid is present in an amount sufficient to particularly adversely affect the viability of the cells of the bacteria in the method as described herein.

In an aspect, the liquid egg formulation is heated to form the pre-cooked egg food product. The citric acid, and the secondary organic acid or salt are provided in the liquid egg formulation in an amount sufficient to form a pre-cooked egg food product having a pH of from about 5.5 to about 6.25. The pre-cooked egg food product is packaged and stored under refrigerated conditions for a period of time prior to consumption. The thus prepared pre-cooked egg food product exhibits surprisingly good control of Listeria growth that can even exceed the degree of control recommended by the USDA without adverse effects on organoleptic properties.

In an aspect, the antibacterial composition is combined with the liquid egg material in an amount effective to limit the average growth of Listeria to less than 2 log in the packaged pre-cooked egg food product during refrigeration for at least about 40 days. In an aspect, the pre-cooked egg material is frozen for storage and/or transport prior to being displayed under refrigeration conditions for subsequent use or sale.

The resulting product provides significant storage and use convenience to the consumer in a ready-to-eat format or ready-to-reheat format. Moreover, the final product may exhibit excellent organoleptic characteristics without unpleasant off-flavors often associated with refrigerated food products that have been stored under refrigeration conditions for a long time.

For purposes of the present discussion, the evaluation of growth of Listeria is carried out by conducting a surface inoculation of packaged egg products as described in the Examples section herein.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is graph showing log counts of Listeria in various formulations.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

The liquid egg material may be prepared in a conventional manner, such as by shelling and mixing whole eggs to provide a generally homogenous liquid egg mixture. In an aspect, liquid egg material may comprise whole egg, egg white, egg yolk, egg substitute, egg powder, and combinations thereof. Various ingredients can be added to the liquid egg mixture, including water, dairy derivatives, oils, starches, thickeners, humectants, preservatives and/or flavorants.

In an aspect, the liquid egg material may be pasteurized according to conventional methods. Pasteurization is generally accomplished by heating the liquid egg material at a sufficient temperature and for a sufficient period of time to kill certain types of bacteria that may be present in the liquid eggs.

Pasteurization is optional, but can be carried out before, after or during the addition of the antibacterial composition described below.

In an aspect, the antibacterial composition comprises nisin, citric acid, and an organic acid or salt selected from the group consisting of lactic acid or salts thereof, acetic acid or salts thereof, propionic acid or salts thereof, sorbic acid or salts thereof, benzoic acids or salts thereof, and mixtures thereof. In an aspect, the components may be combined prior to being added to the liquid egg material. In an aspect, the components may be added separately to the liquid egg material.

In an aspect, nisin is added to the liquid egg formulation in an amount of from about 3 to about 6.25 ppm of nisin. In an aspect, nisin is added to the liquid egg formulation in an amount of from about 4 to about 6.25 ppm of nisin. In an aspect, nisin is added to the liquid egg formulation in an amount of from about 5 to about 6.25 ppm of nisin. In an aspect, nisin is added to the liquid egg formulation in an amount of from about 5.5 to about 6.25 ppm of nisin.

Nisin formulations are sold in varying active concentrations under several brand names, and generally include an inorganic salt carrier such as NaCl. Examples of such formulations include Nisaplin® and Novasin™, both available from Danisco A/S (Copenhagen) and Delvonis, available from DSM Food Specialties USA, Inc. It should be noted that, for example, the nisin formulation sold as Nisaplin® is effectively a 40× dilution of nisin.

Citric acid is used in the liquid egg formulation to lower the pH to a pH level whereby the secondary organic acid or salt, when present in combination with the nisin, is effective to provide surprisingly good control of Listeria growth in the final refrigerated product. It has been discovered that citric acid may uniquely be used in the amounts required to achieve this pH level without adversely affecting the texture, flavor, and/or overall organoleptic characteristics of the final product. In an aspect, the citric acid is present in an amount sufficient to form a liquid egg formulation having a pH of from about 5.5 to about 6.25. In an aspect, the citric acid is present in an amount sufficient to form a liquid egg formulation having a pH of from about 5.8 to about 6.1. It is noted that the pH of liquid egg formulations may vary based on the source of raw material egg itself or the age or handling of the egg material. Thus, advantageously pH is measured during preparation of the liquid egg formulation, with addition of the citric acid in an amount effective to achieve the target pH of the liquid egg formulation.

As noted above, the secondary organic acid or a salt thereof that is suitable for use in food, the secondary organic acid having a pKa of from about 3.5 to about 8.

In an aspect, the secondary organic acid or salt is selected from the group consisting of lactic acid or salts thereof, acetic acid or salts thereof, propionic acid or salts thereof, sorbic acid or salts thereof, benzoic acids or salts thereof, and mixtures thereof. In an aspect, the salt of the organic salt is selected from sodium or potassium salts.

In an aspect, the secondary organic acid or salt is present in an amount of from about 0.1% wt to about 3% wt. In an aspect, the secondary organic acid or salt is present in an amount of from about 0.2% wt to about 2% wt. In an aspect, the secondary organic acid or salt is present in an amount of from about 0.3% wt to about 1% wt. In an aspect, the secondary organic acid or salt is present in an amount of from about 0.5% wt to about 1% wt. In an aspect, the secondary organic acid or salt is present in an amount of from about 0.8% wt to about 2.2% wt.

In an aspect, the secondary organic acid or salt is selected from the group consisting of acetic acid, acetate salts or diacetate salts. In an aspect, the secondary organic acid or salt is selected from the group consisting of acetic acid, acetate salts or diacetate salts and the secondary organic acid or salt is present in an amount of from about 0.5% wt to about 1.2% wt.

In an aspect, the secondary organic acid or salt is selected from the group consisting of propionic acid or propionate salts. In an aspect, the secondary organic acid or salt is selected from the group consisting of propionic acid or propionate salts and the secondary organic acid or salt is present in an amount of from about 0.1% wt to about 0.4% wt.

In an aspect, the secondary organic acid or salt is selected from the group consisting of lactic acid or lactate salts. In an aspect, the secondary organic acid or salt is selected from the group consisting of lactic acid or lactate salts and the secondary organic acid or salt is present in an amount of from about 1% wt to about 3% wt.

The secondary organic acid or salt are provided in the liquid egg formulation, together with the citric acid, in an amount sufficient to form a pre-cooked egg food product having a pH of from about 5.5 to about 6.25. In an aspect, the secondary organic acid or salt are provided in the liquid egg formulation in an amount sufficient to form a pre-cooked egg food product that has a pH of from about 5.6 to about 6.0. In an aspect, the secondary organic acid or salt are provided in the liquid egg formulation in an amount sufficient to form a pre-cooked egg food product has a pH of from about 5.7 to about 6.0. In an aspect, the secondary organic acid or salt are provided in the liquid egg formulation in an amount sufficient to form a pre-cooked egg food product that has a pH of from about 5.75 to about 6.0.

In an aspect, the only acids or salts thereof present in the packaged pre-cooked egg food product are selected from citric acid or salts thereof, lactic acid or salts thereof, acetic acid or salts thereof, propionic acid or salts thereof, sorbic acid or salts thereof, benzoic acids or salts thereof, and mixtures thereof. In an aspect, the only acids or salts thereof present in the packaged pre-cooked egg food product are selected from In an aspect, the only acids or salts thereof present in the packaged pre-cooked egg food product are selected from citric acid or salts thereof, acetic acid, acetate salts or diacetate salts.

As noted above, the antibacterial composition is combined with the liquid egg material in an amount effective to limit the average growth of Listeria to than 2 log in the packaged pre-cooked egg food product during refrigeration for at least about 40 days.

In an aspect, the antibacterial composition is combined with the liquid egg material in an amount effective to limit the average growth of Listeria in the packaged pre-cooked egg food product to less than 2 log during refrigeration for at least about 14 weeks. In an aspect, the antibacterial composition is combined with the liquid egg material in an amount effective to limit the average growth of Listeria in the packaged pre-cooked egg food product to less than 2 log during refrigeration for at least about 20 weeks.

In an aspect, the antibacterial composition is combined with the liquid egg material in an amount effective to limit the average growth of Listeria in the packaged pre-cooked egg food product to less than 1 log during refrigeration for at least about 14 weeks. In an aspect, the antibacterial composition is combined with the liquid egg material in an amount effective to limit the average growth of Listeria in the packaged pre-cooked egg food product to less than 1 log during refrigeration for at least about 20 weeks.

In an aspect, the antibacterial composition is combined with the liquid egg material in an amount effective to limit the average growth of Listeria in the packaged pre-cooked egg food product to less than 0.5 log during refrigeration for at least about 20 weeks. In an aspect, the antibacterial composition is combined with the liquid egg material in an amount effective to limit the average growth of Listeria in the packaged pre-cooked egg food product to less than 0.2 log during refrigeration for at least about 20 weeks.

In an aspect, the antibacterial composition is combined with the liquid egg material in an amount effective to prevent growth of Listeria from any initial Listeria content in the packaged pre-cooked egg food product during refrigeration for at least about 14 weeks. In an aspect, the antibacterial composition is combined with the liquid egg material in an amount effective to prevent growth of Listeria from any initial Listeria content in the packaged pre-cooked egg food product during refrigeration for at least about 20 weeks.

In an aspect, the antibacterial composition is combined with the liquid egg material in an amount effective to actually achieve a kill of Listeria in the packaged pre-cooked egg food product. In an aspect, the antibacterial composition is combined with the liquid egg material in an amount effective to provide at least 0.2 log kill of Listeria in the packaged pre-cooked egg food product during refrigeration for at least about 20 weeks. In an aspect, the antibacterial composition is combined with the liquid egg material in an amount effective to provide at least 0.5 log kill of Listeria in the packaged pre-cooked egg food product during refrigeration for at least about 20 weeks. In an aspect, the antibacterial composition is combined with the liquid egg material in an amount effective to provide at least 1 log kill of Listeria in the packaged pre-cooked egg food product during refrigeration for at least about 20 weeks.

In an aspect, food ingredients other than egg may be included in the pre-cooked egg food product as solid food inclusions. In an aspect, food ingredients other than egg may be added to the liquid egg formulation prior to heating, or may be mixed in after the liquid egg formulation has been cooked.

In an aspect, solid food inclusions may be selected from food sources such as cooked meats (such as ham, pork, beef steak portions, ground beef, chicken portions, ground chicken, fish, sausage, and the like, and mixtures thereof), vegetable pieces (such as asparagus, broccoli, beans, peppers, onions, potatoes and the like, and mixtures thereof), grains and legumes (such as quinoa, beans, chick peas, lentils, pulses, and the like, and mixtures thereof) or cheese (such as blue, cheddar, Colby, gouda, Monterey jack, Swiss, and the like, and mixtures thereof), fruit (such as blueberries, raspberries, cranberries, apple, pear, and the like, and mixtures thereof), or bread (such as biscuits, french toast, and the like, and mixtures thereof), and mixtures thereof.

Once the liquid egg material is prepared and the antibacterial composition has been added, the liquid egg material is cooked according to conventional practices to form a pre-cooked egg material. In an aspect, the liquid egg material may be deposited in a plurality of recesses formed in an egg pan. The deposited liquid egg material is then cooked by baking or steaming. In an aspect, the egg pan may be advanced into an impingement oven that applies hot air to the liquid egg material at an operating temperature of between about 160° C. and 175° C. for between about 5 to 10 minutes until the center of the egg material is cooked. In an aspect, the liquid egg material may be scrambled according to conventional practices.

In an aspect, the pre-cooked egg material may be combined with additional food materials and then packaged for distribution and sale as a pre-cooked egg product. In an aspect, the pre-cooked egg product may be in the form of a diced cooked egg product or as scrambled eggs. In an aspect, the pre-cooked egg product may be used in ready-to-eat breakfast sandwiches, burritos, wraps, and other ready-to-eat breakfast products. In an aspect, the pre-cooked egg product can be packaged and sold without additional food materials as well. In an aspect, the pre-cooked egg product can be packaged, frozen, refrigerated and/or transported to a different location prior to being combined with additional foods or subjected to additional packaging.

In an aspect, the pre-cooked egg product is packaged in modified atmosphere packaging (MAP). An example of suitable MAP packaging is an oxygen impermeable membrane or enclosure that contains a low oxygen atmosphere. MAP packaging may also assist in extending the refrigerated shelf life of the pre-cooked egg product.

Once assembled, the packaged pre-cooked egg product may be stored under refrigeration conditions for an extended period prior to consumption while still maintaining suitable levels of Listeria growth. In an aspect, the pre-cooked egg product may be stored under refrigeration conditions at a temperature of from about 32° F. to about 45° F. In an aspect, the pre-cooked egg product may be stored under refrigeration conditions at a temperature of from about 34° F. to about 40° F.

The ability to refrigerate the ready-to-eat food product while still maintaining acceptable levels of Listeria growth provides improved flexibility in the distribution, sale and use of products prepared according to aspects of the present invention. In an aspect, the product may be frozen after assembly of the packaged pre-cooked egg product and maintained in the frozen state during temporary storage or during resale and/or distribution. The packaged pre-cooked egg product is then allowed to thaw for distribution or sale. In an aspect, the packaged pre-cooked egg product is then allowed to thaw by being placed in a refrigerated display cooler for retail sale. In an aspect, the product may remain frozen up through sale, but can be subsequently refrigerated until consumption. In yet another aspect, the product may be maintained in a refrigerated, never frozen state from packaging through consumption.

In an aspect, the refrigerated egg product is free of added bacteria that produces novel bacteriocins or metabolites which inhibit or kill the spoilage and pathogenic bacteria.

In an aspect, the refrigerated egg product has not been exposed to pressures exceeding 100 MPa. This aspect may be advantageous because some people object to processing of food by a pressure treatment.

In an aspect, the refrigerated egg product has not been exposed to irradiation treatment.

In an aspect, the pre-cooked egg food product is treated with topical application of an additional antibacterial treatment composition prior to being packaged. In an aspect, the additional antibacterial treatment composition is applied directly to the pre-cooked egg food product. In an aspect, the additional antibacterial treatment composition is applied directly to the inside of the package prior to insertion of the pre-cooked egg food product and sealing of the package.

In an aspect, the additional antibacterial treatment composition comprises bacteria that produces novel bacteriocins or metabolites which inhibit or kill the spoilage and pathogenic bacteria. In an aspect, the additional antibacterial treatment composition comprises an additive known to kill or neutralize bacteria or other kinds of microbes. In an aspect, the additional antibacterial treatment composition comprises any substance approved by the United States Department of Agriculture Food Safety and Inspection service for use as an antimicrobial treatment of meat, poultry and egg products. Listings of such materials are updated at https://www.fsis.usda.gov.

In an aspect, the additional antibacterial treatment composition comprises a compound selected from the group consisting of acetic acid; acidified sodium chlorite; ammonium sulfate; calcium hypochlorite; cetylpyridinium chloride; chlorine; citric acid; copper sulfate; 1,3-dibromo-5,5 dimethylhydantoin (DBDMH); dipicolinic acid (DPA); hydrochloric acid; hydrogen peroxide (HP); 1-hydroxyethylidene-1,1-diphosphonic acid (HEDP); hypochlorous acid; octanoic acid; peroxyacetic acid (PAA); sodium hypochlorite; sodium sulfate; sulfuric acid; trisodium phosphate (TSP); lactic acid; and mixtures thereof.

In an aspect, the pre-cooked egg food product is not treated with topical application of an additional antibacterial treatment composition prior to being packaged. This aspect may be advantageous because the incorporation of an additional treatment step is avoided, thereby simplifying the process and reducing cost by reduction of materials employed and purchase and maintenance of equipment. It has surprisingly been found the use of the present antibacterial composition as a treatment that is mixed only as a component of the liquid egg formulation without additional treatment is effective in providing excellent performance in limiting the average growth of Listeria as described herein. Additionally, it has been found advantageous to reduce the number of additives incorporated in the pre-cooked egg food product to provide a “clean” label.

As discussed above, the present methods provide refrigerated pre-cooked egg food products that exhibit surprisingly good control of Listeria growth. In an aspect, the average growth of Listeria in the packaged pre-cooked egg food product during refrigeration is evaluated on the basis of comparison of packaged pre-cooked egg food product sampled from the same lot to determine the relative growth (or kill) of Listeria natively present in the product.

In a separate aspect, and when expressly stated, the control of Listeria growth in Commercial Packaged Pre-Cooked Egg Food Product during refrigeration is evaluated obtaining commercially available packaged pre-cooked egg food product, for example, from the grocery store shelf, and conducting the Listeria Inoculation and evaluation procedure described in the Examples section below. In an aspect, the commercially available packaged pre-cooked egg food product is obtained at least 20 weeks before its labelled “sell by” date, or its labelled “use by” date, or its labelled “expiration” date, as applicable. In an aspect, the commercially available packaged pre-cooked egg food product is obtained at least 15 weeks before its labelled “sell by” date, or its labelled “use by” date, or its labelled “expiration” date, as applicable. In an aspect, the commercially available packaged pre-cooked egg food product is obtained at least 10 weeks before its labelled “sell by” date, or its labelled “use by” date, or its labelled “expiration” date, as applicable. In an aspect, the commercially available packaged pre-cooked egg food product is obtained at least 40 days before its labelled “sell by” date, or its labelled “use by” date, or its labelled “expiration” date, as applicable. In an aspect, the commercially available packaged pre-cooked egg food product is obtained at least 20 days before its labelled “sell by” date, or its labelled “use by” date, or its labelled “expiration” date, as applicable.

In an aspect, the Commercial Packaged Pre-Cooked Egg Food Product exhibits limitation of the average growth of Listeria to less than 2 log during refrigeration for at least about 40 days.

In an aspect, the Commercial Packaged Pre-Cooked Egg Food Product exhibits limitation of the average growth of Listeria to less than 2 log during refrigeration for at least about 14 weeks. In an aspect, the Commercial Packaged Pre-Cooked Egg Food Product exhibits limitation of the average growth of Listeria to less than 2 log during refrigeration for at least about 20 weeks.

In an aspect, the Commercial Packaged Pre-Cooked Egg Food Product exhibits limitation of the average growth of Listeria to less than 1 log during refrigeration for at least about 14 weeks. In an aspect, the Commercial Packaged Pre-Cooked Egg Food Product exhibits limitation of the average growth of Listeria to less than 1 log during refrigeration for at least about 20 weeks.

In an aspect, the Commercial Packaged Pre-Cooked Egg Food Product exhibits limitation of the average growth of Listeria to less than 0.5 log during refrigeration for at least about 20 weeks. In an aspect, the Commercial Packaged Pre-Cooked Egg Food Product exhibits limitation of the average growth of Listeria to less than 0.2 log during refrigeration for at least about 20 weeks.

In an aspect, the Commercial Packaged Pre-Cooked Egg Food Product exhibits no growth of Listeria from any initial Listeria content in the Commercial Packaged Pre-Cooked Egg Food Product during refrigeration for at least about 14 weeks. In an aspect, the Commercial Packaged Pre-Cooked Egg Food Product exhibits no growth of Listeria from any initial Listeria content in the Commercial Packaged Pre-Cooked Egg Food Product during refrigeration for at least about 20 weeks.

In an aspect, the Commercial Packaged Pre-Cooked Egg Food Product exhibits a kill of Listeria in the Commercial Packaged Pre-Cooked Egg Food Product. In an aspect, the Commercial Packaged Pre-Cooked Egg Food Product exhibits at least 0.2 log kill of Listeria in the Commercial Packaged Pre-Cooked Egg Food Product during refrigeration for at least about 20 weeks. In an aspect, the Commercial Packaged Pre-Cooked Egg Food Product exhibits at least 0.5 log kill of Listeria in the Commercial Packaged Pre-Cooked Egg Food Product during refrigeration for at least about 20 weeks. In an aspect, the Commercial Packaged Pre-Cooked Egg Food Product exhibits at least 1 log kill of Listeria in the Commercial Packaged Pre-Cooked Egg Food Product during refrigeration for at least about 20 weeks.

### EXAMPLES

### 1. Preparation of Egg Samples

Pre-cooked egg food products were prepared using the formulation as shown in Table 1:

TABLE 1

| | |
|---|---|
| Pasteurized Whole Eggs | (94.2050-95.025)% |
| Citric Acid | (0.2900-0.4200)% |
| Cold-Swell Corn Starch | 1.0000% |
| Soybean Oil | 2.5000% |
| Carrageenan | 0.4000% |
| Salt | 0.4500% |
| Nisaplin ™ | 0.0250% |
| organic acid or salt | Various levels shown below |

Specific formulations were prepared by incorporating organic acid or salts as indicated in Table 2:

TABLE 2

| | organic acid or | organic acid or | |
|---|---|---|---|
| Formulation | salt | salt Product Name | Amount used |
| Formulation A | acetate | Corbion ™ | 1.0% |
| | | OptiPowder | |
| | | N450 ™ | |
| Formulation B | propionate | Kemin ™ BC-6 ™ | 0.3% |
| (comparative) | | | |
| Formulation C | acetate and | Niacet ™ Provian | 1.0% |
| | diacetate | K ™ | |
| Formulation D | acetate and | Niacet ™ Provian | 0.6% |
| | diacetate | K ™ | |
| Formulation E | lactate | Corbion ™ Purasal | 2.0% |
| (comparative | | Powder S 100 ™ | |

Formulation blending was carried out using an Immersion Blender to homogenize the liquid mixture. The liquid mixture was deposited onto a non-stick-sprayed, full-sized aluminum hotel pan at an amount of 1000 g. The hotel pan was inserted into an oven and cooked at 100% steam settings for a period of 4.75 min until product temperature at the inner-center reached at least 165° F.

The cooked slab was deposited from the hotel pan onto a sheet of parchment paper. It was diced into approximately ¼×¼×¼″ pieces. The diced product was placed in a plastic bag with powdered CO₂ and tossed until sufficiently frozen (<0° F.). The frozen product was retained in those bags in a freezer for temporary transport.

Portions of approx. 30 g each of frozen diced eggs were placed and packaged in individual plastic cushion style pouch with modified head space gas composition of N₂:CO₂ 80:20 and sealed. The MAP packaged product samples were stored at chiller maintained at 30° F. until inoculation within five days.

### 2. Physicochemical Composition Analysis of Egg Samples

The physicochemical composition of the formulations were analyzed in triplicates. On the day of sample MAP packaging, three individual packaged samples pulled randomly selected, and individual sample packs were ground for analysis. In order to measure pH, 10 g of ground sample was homogenized in 10 ml of deionized water. The pH was measured on the resulted slurry. Moisture content was determined by drying at 125° C. for 3 hr (Ankom Technology, NY, USA), salt was measured as Cl⁻ by potentiometric titration (Ultra Scientific, Omnion, RI, USA). The water activity was measured using a water activity meter. The fat and protein content were measured as near infrared transmittance (Food Scan™, Foss, Denmark).

### 3. Listeria Inoculum Preparation

Listeria monocytogenes strains, LM 101 (hard salami isolate, serotype 4b), LM 108 (hard salami isolate, serotype 1/2b), FSL-CI-109 (human isolate, serotype 4b), LM 132 (hard salami isolate, serotype 1/2a), and LM 310 (goat milk cheese isolate, serotype 4b), were maintained as frozen stock at −80° F. For the study, strains were grown individually in 10 ml of Trypticase soy broth (TSB) at 35° C. for 18 to 20 h. After incubation, the purity of each strain was verified by streaking on Modified Oxford agar and Trypticase soy agar. To prepare cold stress-adapted cells, the freshly grown cultures were transferred (0.1 ml) to individual 10 ml TSB and incubated at 10° C. for 10 days. After completion of the incubation, equivalent populations of each isolate were combined to obtain a five-strain mixture of L. monocytogenes. The mix was serially diluted in 0.1% peptone water. Populations of each strain and the mixture were enumerated.

### 4. Listeria Inoculation, Sample Incubation and Analysis

The growth in populations of Listeria monocytogenes was assessed following the guidelines of the National Advisory Committee on Microbiological Criteria for Foods. To evaluate the growth potential for Listeria, individual MAP packaged egg product samples were surface inoculated with Listeria monocytogenes cocktail to deliver approximately 2.5-log CFU/g of product. Specifically, the top film of a sealed (unopened) MAP package was sanitized with 70% isopropyl alcohol and a sticky nickel placed on top, then sanitized. A 0.5 ml of inoculum was syringed and stuck through the sanitized sticky nickel, spread over the product. Another piece of sticky nickel was placed on top of the first sticky nickel. Then the content inside the pack was mixed thoroughly by hand shaking for about 10 secs to spread the inoculum. Inoculated samples were stored at 40° F. The storage temperature was monitored every four hours by using an I-button temperature recorder (Maxim Integrated Inc., CA, USA).

Populations of Listeria monocytogenes were enumerated from five packages at Day 0 and from three packages at each subsequent time points. Individual sample bag was well shaken for about 10 secs, cut open from the top end, and then transferred to a sterile plastic bag built with a filter lining inside to help draw an aliquot. Then, 50 ml of 0.1% peptone water was added and stomached (homogenized) for approx. 2 mins. The homogenate obtained (0.1 ml) was spread plated on Modified Oxford Base (MOX) agar supplemented with antibiotic. The plates were incubated at 35° C. for 48 hrs. Plates with 25-250 representative colonies were counted and reported.

### 5. Changes in Head Space Gas Composition, Organoleptic Quality, Background Microflora, and Product pH During Storage

The head space gas composition, populations of total aerobic plate (APC), total anaerobic plate counts (AnPC), yeast and molds (YM) and pH in uninoculated control samples were assessed from duplicate unopened MAP packages throughout the study.

The head space (CO2 and O2%) inside the MAP package (uninoculated control) was analyzed by using CheckPoint II portable headspace analyzer (Mocon Inc., MN, USA). The top film of a sealed (unopened) MAP package was sanitized with 70% isopropyl alcohol and aseptically pierced in (through previously applied stick nickel) using the gas analyzer needle to measure the gas composition. Samples were then aseptically opened and subjectively analyzed for changes in odor and color.

From each MAP package, portion of sample (20 g) were homogenized/stomached with 0.1% peptone water to achieve 1:10 dilution. From the bag, one ml of the homogenate each was aseptically dispensed on 3M Aerobic Plant Count (APC) Petrifilm, 3M Anaerobic Plant Count (AnPC) Petrifilm and 3M YM Petrifilm. APC film incubated at 35° C. for 24 hours, AnPC film incubated anaerobically at 24° C. for 72 hours and colonies counted and reported as total aerobic plate counts and total anaerobic plate counts, respectively. YM film incubated at 25° C. for 5 days and colonies counted and reported as total yeast molds counts. The limit of detection was one log CFU/g (10 cfu/g). The pH was measured on the original 1:10 homogenized samples. Like the Listeria inoculated samples, these samples were also stored at 40° F. and samples were tested at each time point at which the growth of Listeria was evaluated.

### 6. Experimental Design

Five product formulations were evaluated in this study. The formulations were different by the type and the quantity of antimicrobials in the formulation. These antimicrobials were supplied by three different vendors. The populations of Listeria monocytogenes were enumerated from five packages at Day 0 and from three packages at each subsequent time points.

At each time point, head-space gas composition in product package, organoleptic, populations of total aerobics, total anaerobes, yeast and molds and pH of samples were assessed from duplicate un-inoculated control MAP packages.

Samples were tested at Day 0 (inoculation day) and weeks 4, 6, 8, 10, 12, 13, 14, 15, 16, 17, 18, 19, 20. Two independent replicate trials of the study were performed.

For statistical analysis, microbial counts were transformed to log scale and reported as mean±SD of all samples and trials. Other analyzed values were also reported as mean±SD. Means were compared with Tukey's HSD test at a 95% significance level using JMP software.

### 7. Results and Discussion

The physiochemical composition of the five formulations A-E are presented in Table 3 below.

TABLE 3
Physicochemical characteristics of product formulations as analyzed within five days of packaging

| Formulations | pH | | Moisture (%) | | Salt (%) | | Aw | | Protein (%) | | Fat (%) | |
|---|---|---|---|---|---|---|---|---|---|---|---|---|
| A | 5.80 ± 0.00 | b | 72.8 ± 0.3 | ab | 0.7 ± 0.0 | a | 0.996 ± 0.002 | a | 14.4 ± 0.0 | bc | 10.8 ± 0.1 | ab |
| B | 5.93 ± 0.01 | b | 72.2 ± 0.3 | ab | 0.7 ± 0.0 | a | 0.999 ± 0.003 | a | 14.8 ± 0.2 | ab | 10.9 ± 0.5 | ab |
| C | 5.81 ± 0.01 | b | 71.6 ± 0.3 | b | 0.7 ± 0.0 | a | 0.991 ± 0.012 | a | 15.1 ± 0.0 | a | 11.2 ± 0.2 | a |
| D | 6.24 ± 0.18 | a | 73.0 ± 0.3 | a | 0.6 ± 0.0 | b | 0.997 ± 0.002 | a | 14.3 ± 0.4 | c | 10.3 ± 0.6 | b |
| E | 6.28 ± 0.04 | a | 72.4 ± 0.4 | ab | 0.6 ± 0.0 | b | 0.993 ± 0.004 | a | 12.1 ± 0.0 | d | 10.9 ± 0.1 | ab |

Data are expressed as averages ± standard deviations from two independent trials
Values in the same column that are not followed by the same letter are significantly different (p < 0.05).

In uninoculated controls, the head space gas composition (CO₂ and O₂%) in the packages for all formulations varied slightly but no significant (p>0.05) trend in either increase or decrease of gas compositions were noted during storage at 40° F. for 20 weeks.

Likewise, there was an absence of significant trend (p>0.05) in pH variation of product for all formulations. In general, the total aerobic plate counts and anaerobic plate counts in all samples were not detected (<1 log CFU/g). In few cases, where one or two colonies were recovered, the counts were less than 1.5 log CFU/g. Similarly, yeast and molds were not detected (<1 log CFU/g) in all samples during storage at 40° F. for 20 weeks. All these observations in the uninoculated controls verified that Listeria was provided optimum growth conditions without any interference from background microflora. Also, subjective evaluation of product samples after opening of the packages showed minimal changes in product color and odor.

Product pH and package head space gas measurements are provided in TABLES 4a, 4b and 4c below.

TABLE 4a
Product pH and package head space gas composition in egg formulations stored at 40° f. for 20 weeks

| | Formulation A | | | Formulation B | | |
|---|---|---|---|---|---|---|
| Weeks | pH | CO2% | O2% | pH | CO2% | O2% |
| 0 | 6.06 ± 0.06 ab | 19.4 ± 0.8 b | 0.6 ± 0.8 a | 6.23 ± 0.03 ab | 19.6 ± 0.2 b | 0.3 ± 0.2 a |
| 4 | 6.17 ± 0.10 a | 20.6 ± 0.3 a | 0.2 ± 0.1 a | 6.29 ± 0.06 a | 20.8 ± 0.2 a | 0.1 ± 0.2 a |
| 6 | 6.05 ± 0.01 b | 18.4 ± 0.3 c | 0.2 ± 0.2 a | 6.27 ± 0.03 a | 18.2 ± 0.3 cd | 0.3 ± 0.2 a |
| 8 | 6.09 ± 0.02 ab | 18.3 ± 0.2 c | 0.3 ± 0.2 a | 6.26 ± 0.02 a | 18.1 ± 0.2 cd | 0.2 ± 0.1 a |
| 10 | 6.09 ± 0.01 ab | 17.8 ± 0.2 c | 0.6 ± 0.2 a | 6.26 ± 0.02 a | 17.2 ± 1.0 d | 0.4 ± 0.2 a |
| 11 | 6.07 ± 0.02 ab | 19.6 ± 0.3 b | 0.8 ± 0.4 a | 6.28 ± 0.02 a | 19.9 ± 0.5 ab | 0.2 ± 0.1 a |
| 12 | 6.06 ± 0.05 b | 20.1 ± 0.1 ab | 0.2 ± 0.2 a | 6.24 ± 0.02 ab | 20.0 ± 0.3 ab | 0.4 ± 0.3 a |
| 13 | 6.07 ± 0.04 ab | 19.8 ± 0.3 ab | 0.4 ± 0.3 a | 6.24 ± 0.03 ab | 19.8 ± 0.3 ab | 0.4 ± 0.3 a |
| 14 | 6.07 ± 0.04 ab | 19.7 ± 0.4 b | 0.4 ± 0.2 a | 6.26 ± 0.07 a | 19.3 ± 0.6 bc | 0.5 ± 0.3 a |
| 15 | 6.09 ± 0.03 ab | 19.4 ± 0.5 b | 0.4 ± 0.3 a | 6.24 ± 0.03 ab | 19.8 ± 0.1 ab | 0.2 ± 0.1 a |
| 16 | 6.04 ± 0.05 b | 18.1 ± 0.2 c | 0.3 ± 0.2 a | 6.24 ± 0.02 ab | 17.7 ± 0.0 d | 0.5 ± 0.2 a |
| 17 | 6.07 ± 0.01 ab | 17.9 ± 0.2 c | 0.5 ± 0.2 a | 6.21 ± 0.02 ab | 17.8 ± 0.4 d | 0.2 ± 0.2 a |
| 18 | 6.07 ± 0.02 ab | 18.0 ± 0.2 c | 0.2 ± 0.1 a | 6.26 ± 0.02 a | 17.3 ± 0.8 d | 0.4 ± 0.4 a |
| 20 | 5.99 ± 0.02 b | 20.1 ± 0.4 ab | 0.2 ± 0.2 a | 6.16 ± 0.05 b | 19.9 ± 0.2 ab | 0.3 ± 0.2 a |

Data are expressed as averages ± standard deviations from two independent trials
Values in the same column that are not followed by the same letter are significantly different (p < 0.05)

TABLE 4b

| | Formulation C | | | Formulation D | | |
|---|---|---|---|---|---|---|
| Weeks | pH | CO2% | O2% | pH | CO2% | O2% |
| 0 | 6.05 ± 0.02 bcd | 20.0 ± 0.2 a | 0.2 ± 0.3 a | 6.46 ± 0.22 a | 19.6 ± 0.4 ab | 0.4 ± 0.2 a |
| 4 | 6.21 ± 0.07 a | 20.5 ± 0.4 a | 0.3 ± 0.2 a | 6.46 ± 0.16 a | 18.2 ± 0.3 abc | 0.2 ± 0.1 a |
| 6 | 6.08 ± 0.01 bcd | 18.1 ± 0.3 b | 0.4 ± 0.3 a | 6.47 ± 0.15 a | 18.3 ± 0.3 abc | 0.3 ± 0.2 a |
| 8 | 6.09 ± 0.01 abc | 17.8 ± 0.3 b | 0.5 ± 0.3 a | 6.43 ± 0.18 a | 18.0 ± 0.6 abc | 0.3 ± 0.1 a |
| 10 | 6.10 ± 0.01 abc | 18.1 ± 0.2 b | 0.4 ± 0.2 a | 6.46 ± 0.17 a | 19.8 ± 0.2 a | 0.3 ± 0.1 a |
| 11 | 6.10 ± 0.02 abc | 19.9 ± 0.3 a | 0.4 ± 0.3 a | 6.46 ± 0.16 a | 19.6 ± 0.1 ab | 0.2 ± 0.1 a |
| 12 | 6.09 ± 0.02 abcd | 19.7 ± 0.5 a | 0.5 ± 0.4 a | 6.47 ± 0.17 a | 19.0 ± 0.7 abc | 0.4 ± 0.2 a |
| 13 | 5.99 ± 0.04 cd | 19.8 ± 0.6 a | 0.5 ± 0.4 a | 6.42 ± 0.15 a | 18.8 ± 0.4 abc | 0.4 ± 0.2 a |
| 14 | 6.11 ± 0.02 ab | 19.8 ± 0.3 a | 0.3 ± 0.3 a | 6.44 ± 0.17 a | 17.7 ± 0.3 bcd | 0.4 ± 0.3 a |
| 15 | 6.07 ± 0.07 bcd | 19.8 ± 0.2 a | 0.2 ± 0.2 a | 6.44 ± 0.13 a | 17.5 ± 0.5 cd | 0.5 ± 0.2 a |
| 16 | 6.11 ± 0.08 ab | 17.9 ± 0.2 b | 0.4 ± 0.2 a | 6.45 ± 0.16 a | 17.5 ± 0.4 cd | 0.3 ± 0.1 a |
| 17 | 6.07 ± 0.01 bcd | 17.9 ± 0.3 b | 0.4 ± 0.2 a | 6.38 ± 0.15 a | 15.9 ± 2.5 d | 1.9 ± 1.9 a |
| 18 | 6.09 ± 0.00 abc | 18.0 ± 0.3 b | 0.3 ± 0.1 a | 6.42 ± 0.18 a | 19.2 ± 0.3 abc | 0.2 ± 0.1 a |
| 20 | 5.99 ± 0.04 d | 20.1 ± 0.2 a | 0.3 ± 0.2 a | 6.38 ± 0.13 a | 19.5 ± 0.5 abc | 0.3 ± 0.1 a |

TABLE 4c

Formulation E

| Weeks | pH | CO2% | O2% |
|---|---|---|---|
| 0 | 6.46 ± 0.04 ab | 19.4 ± 0.3 a | 0.3 ± 0.1 a |
| 4 | 6.43 ± 0.05 b | 19.6 ± 0.3 a | 0.1 ± 0.1 a |
| 6 | 6.50 ± 0.02 ab | 19.7 ± 0.8 a | 0.2 ± 0.3 a |
| 8 | 6.52 ± 0.05 a | 19.3 ± 0.4 a | 0.2 ± 0.1 a |

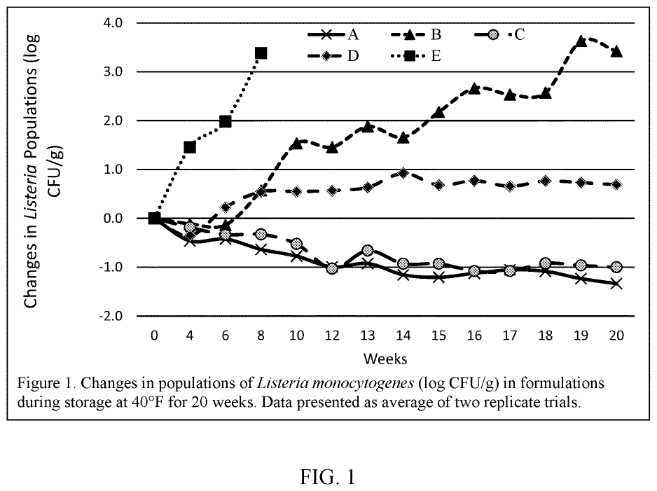

The formulations were inoculated with 2.5±0.3 log CFU/g of Listeria monocytogenes, and count measurements were taken weekly for 20 weeks. Count data is presented in Table 5, which is presented graphically in FIG. 1.

TABLE 5
Listeria monocytogenes counts in egg formulations stored at 40° F. for 20 weeks

| | | Formulations | | | | |
|---|---|---|---|---|---|---|
| Weeks | n | A | B | C | D | E |
| 0 | 10 | 2.5 ± 0.1 a | 2.3 ± 0.2 g | 2.3 ± 0.2 a | 3.0 ± 0.1 a | 2.2 ± 0.1 d |
| 4 | 6 | 2.0 ± 0.2 b | 2.2 ± 0.2 g | 2.1 ± 0.1 ab | 2.6 ± 0.6 a | 3.7 ± 0.4 c |
| 6 | 6 | 2.0 ± 0.1 b | 2.2 ± 0.2 g | 1.9 ± 0.4 abc | 3.2 ± 0.7 a | 4.2 ± 0.3 b |
| 8 | 6 | 1.8 ± 0.2 bc | 2.9 ± 0.2 fg | 1.9 ± 0.1 abc | 3.5 ± 0.7 a | 5.6 ± 0.4 a |
| 10 | 6 | 1.7 ± 0.4 bcd | 3.9 ± 0.6 e | 1.7 ± 0.2 bcd | 3.6 ± 0.7 a | NA |
| 11 | 6 | 1.5 ± 0.2 cde | 3.8 ± 0.5 ef | 1.2 ± 0.2 e | 3.6 ± 0.7 a | NA |
| 12 | 6 | 1.5 ± 0.3 cde | 4.2 ± 0.3 cde | 1.6 ± 0.1 cde | 3.6 ± 0.8 a | NA |
| 13 | 6 | 1.3 ± 0.2 de | 4.0 ± 0.2 de | 1.3 ± 0.2 de | 3.9 ± 1.4 a | NA |
| 14 | 6 | 1.3 ± 0.2 e | 4.5 ± 0.4 cde | 1.3 ± 0.2 de | 3.7 ± 0.8 a | NA |
| 15 | 6 | 1.3 ± 0.2 de | 5.0 ± 0.7 bc | 1.2 ± 0.1 e | 3.8 ± 1.1 a | NA |
| 16 | 6 | 1.4 ± 0.2 cde | 4.9 ± 0.5 bcd | 1.2 ± 0.1 e | 3.7 ± 1.1 a | NA |
| 17 | 6 | 1.4 ± 0.2 de | 4.9 ± 0.6 bc | 1.3 ± 0.3 de | 3.8 ± 1.3 a | NA |
| 18 | 6 | 1.2 ± 0.2 e | 6.0 ± 0.6 a | 1.3 ± 0.3 e | 3.7 ± 1.4 a | NA |
| 20 | 6 | 1.1 ± 0.0 e | 5.8 ± 0.7 ab | 1.3 ± 0.2 e | 3.7 ± 1.7 a | NA |

Data are expressed as averages ± standard deviations from two independent trials
Values in the same column that are not followed by the same letter are significantly different (p < 0.05)
NA—not analyzed
For statistical purpose, samples with undetected Listeria colonies were set as 1.1-log CFU/g (limit of detection)

Listeria did not grow in formulations A and C. Although not intended, the counts in both formulations declined significantly (p<0.05) overtime demonstrating at least one log kill (FIG. 1 and Table 3) during storage at 40° F. over the 20 weeks period. Formulation B supported significant (p<0.05) growth of at least 2 log CFU/g by week 15 and Listeria continued to grow thereafter during storage. Formulation D showed Listeria counts Although not significant (p>0.05) overtime, the formulation supported about one log growth in average over 20 weeks storage. Formulation E supported significant growth (p<0.05) with counts increasing by 2 log CFU/g within week 6. The evaluation of formulation E was terminated at week 8 due to greater than 3 log growth in Listeria counts.

### 8. Conclusion

Formulations A and C inhibited growth and resulted in at least one log kill of Listeria during storage at 40° F. for 20 weeks. Hence, both A and C demonstrated control of Listeria during shelf life. Formulation D limited the average growth of Listeria to less than 1 log during storage at 40° F. for 20 weeks and therefore also provided excellent control of Listeria during shelf life.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method for preparing a refrigerated pre-cooked egg food product, the method comprising:
combining a liquid egg material with an antibacterial composition comprising nisin, citric acid, and a secondary organic acid or salt to form a liquid egg formulation, the liquid egg formulation comprising
nisin in an amount of about 6.25 ppm or less,
citric acid, and
a secondary organic acid or a salt thereof that is suitable for use in food, the secondary organic acid having a pKa of from about 3.5 to about 8;
heating the liquid egg formulation to form the pre-cooked egg food product, wherein the citric acid, and the secondary organic acid or salt are provided in the liquid egg formulation in an amount sufficient to form a pre-cooked egg food product having a pH of from about 5.5 to about 6.3;
packaging the pre-cooked egg food product; and
storing the packaged pre-cooked egg food product under refrigerated conditions for a period of time prior to consumption,
wherein the antibacterial composition is combined with the liquid egg material in an amount effective to limit the average growth of Listeria to less than 2 log in the packaged pre-cooked egg food product during refrigeration for at least about 40 days.

2. The method of claim 1, wherein the secondary organic acid has a pKa of from about 4 to about 6; or wherein the secondary organic acid has a pKa of from about 4 to about 5.

3. The method of claim 1, wherein the secondary organic acid is an organic acid or salt selected from the group consisting of lactic acid or salts thereof, acetic acid or salts thereof, propionic acid or salts thereof, sorbic acid or salts thereof, benzoic acid or salts thereof, and mixtures thereof

4. The method of claim 1, wherein the pre-cooked egg food product has a pH of from about 5.6 to about 6.0.

5. The method of claim 1, wherein the citric acid is present in an amount sufficient to form a liquid egg formulation having a pH of from about 5.5 to about 6.25.

6. The method of claim 1, wherein the liquid egg formulation comprises from about 3 to about 6.25 ppm of nisin.

7. The method of claim 1, wherein the secondary organic acid or salt is present in an amount of from about 0.1% wt to about 3% wt.

8. The method of claim 1, wherein the secondary organic acid or salt is selected from the group consisting of acetic acid, acetate salts or diacetate salts and the secondary organic acid or salt is present in an amount of from about 0.5% wt to about 1.2% wt.

9. The method of claim 1, wherein the secondary organic acid or salt is selected from the group consisting of propionic acid or propionate salts and the secondary organic acid or salt is present in an amount of from about 0.1% wt to about 0.4% wt.

10. The method of claim 1, wherein the secondary organic acid or salt is selected from the group consisting of lactic acid or lactate salts and the secondary organic acid or salt is present in an amount of from about 1% wt to about 3% wt.

11. The method of claim 1, wherein the antibacterial composition is combined with the liquid egg material in an amount effective to limit the average growth of Listeria in the packaged pre-cooked egg food product to less than 2 log during refrigeration for at least about 14 weeks.

12. (canceled)

13. The method of claim 1, wherein the antibacterial composition is combined with the liquid egg material in an amount effective to limit the average growth of Listeria in the packaged pre-cooked egg food product to less than 0.5 log during refrigeration for at least about 20 weeks.

14. (canceled)

15. The method of claim 1, wherein the antibacterial composition is combined with the liquid egg material in an amount effective to provide at least 0.2 log kill of Listeria in the packaged pre-cooked egg food product during refrigeration for at least about 20 weeks.

16. The method of claim 1, wherein the packaging step includes packaging the pre-cooked egg material in low oxygen modified atmosphere packaging.

17. The method of claim 1, further comprising the step of freezing the packaged pre-cooked egg food product.

18. The method of claim 1, wherein the packaged pre-cooked egg food product further comprises solid food inclusions selected from cooked meats vegetable pieces, grains and legumes, cheese, fruit, bread, and mixtures thereof.

19. The method of claim 1, wherein the packaged pre-cooked egg food product is a diced cooked egg product.

20. The method of claim 1, wherein the packaged pre-cooked egg food product is a ready-to-eat product selected from the group consisting of scrambled eggs, breakfast sandwiches, breakfast burritos and wraps.

21. A packaged pre-cooked egg food product made by the process of claim 1.

22. The packaged pre-cooked egg food product of claim 21, wherein the packaged pre-cooked egg food product is a Commercial Packaged Pre-Cooked Egg Food Product that exhibits limitation of the average growth of Listeria to less than 2 log during refrigeration for at least about 14 weeks.
